(19) United States
(12) Patent Application Publication
(10) Pub. No.: US 2003/0198544 A1
(43) Pub. Date: Oct. 23, 2003

(54) Centralized cargo transfer system using a movable transfer dock

(76) Inventors: Tom Campbell, Ridgedale, MO (US); Art Shoener, Fishers, IN (US)

Correspondence Address: Daniel H. Shulman, MAYER, BROWN, ROWE & MAW, P.O. Box 2828, Chicago, IL, 60690, US

(21) Appl. No.: 10/126,290

(22) Filed: Apr. 19, 2002

(51) Int. Cl. B65G 63/00

(52) U.S. Cl. 414/340; 414/344

(57) ABSTRACT

Disclosed is a system for centralized transfer of cargo to and from rail cars comprising a first railway to accommodate the rail cars; a staging area; and a second railway positioned between the first railway and the staging area to accommodate a movable transfer dock; wherein the cargo is transferred between the staging area and the rail cars via the movable transfer dock. Also disclosed is a movable transfer dock for facilitating the transfer of cargo between a staging area and a rail car, comprising: a movable platform having a plurality of wheels thereunder to support the platform on a plurality of rails; a mechanism to allow for facile movement of cargo; and a pressurized air source mounted to the platform. Also disclosed is a cargo container for use with embodiments of the present system.

### BACKGROUND OF THE INVENTION

1. Field of the Invention

The present invention relates to a centralized cargo transfer system using a movable transfer dock. Particularly, the present invention is directed to an improved system for centralizing the transfer of cargo between road and rail utilizing a movable transfer dock.

2. Description of Related Art

The use of railways to transport cargo has long been known in the art. Railway transport has the advantage that large amounts of cargo may be transferred on more or less direct routes between rail served origin and destination locations. This has long provided shippers with lower transportation costs due to the economies of scale over road transportation alternatives.

Although rail does provide shippers with a cost advantage over trucks in transporting goods, typical rail service takes longer and is less reliable than the highway alternative. This is due in part to the extensive car handling processes required by one or more rail-lines to deliver railcars from an origin to a destination point. Additional time is also often lost due to the manual loading and unloading processes of both shippers and customers alike. The combination of these factors not only affects service but also has a direct impact on car utilization and additional revenue opportunities.

Also complicating the rail service alternative is that not all shippers or customers have direct rail access. This, coupled with the demand for service reliability and increased equipment utilization, has driven the need for a form of hybrid transportation utilizing a combination of both rail and truck delivery.

This hybridized transportation solution has evolved in one of three ways. One such solution utilizes common distribution or receiving docks where cars can be switched and spotted and cargo transferred between cars and trucks for delivery. Rail is typically used for the long haul while trucks are used for the short haul either bringing cargo from a shipper to a common distribution center or picking up cargo from a common receiving center and delivering to final destinations. An example of this type of facility is with the shipment of new automobiles where autos are loaded onto specialized auto-rack freight cars at vehicle manufacturing centers and moved via rail to large centralized distribution centers. In this example, autos are then offloaded from the railcars into specialized automobile transport trailers for truck deliveries to local automobile dealers.

The use of the common facility is unsuitable, however, in the typical loading dock operation where goods are shipped utilizing conventional refrigerated or dry boxcars. In that case, re-spotting of cars is often necessary since the docks are stationary and of varying size and configuration. Cars must often be moved to accommodate dockside door locations or to continue the load/unload process. Additionally, loading and unloading of cargo still involves a manual process requiring hand stacking and removal of goods inside the cars or the use of personnel operated fork trucks to handle palletized goods in and out of the car. In some instances, only a portion of the car capacity can be utilized due to the stacking limitations of cargo. In any case, the process is labor intensive, time consuming, and often results in damage to goods or equipment.

A second prior solution is an intermodal process utilizing centralized receiving and distribution centers where truck trailers or cargo containers are trucked in and out and loaded on or unloaded from specially designed rail cars. This is accomplished through the use of large moveable overhead cranes where the trailers or containers are lifted on and off the rail car. Some facilities also utilize specially designed ramps where trailers can be driven directly onto or off specially equipped flat cars. With this process, however, only a maximum of two trailers or two containers can be placed on each rail car. Moreover, the use of specialized crane equipment is both expensive and dangerous. Finally, because of the size and cost of the machinery needed to operate a large intermodal complex, not all depots can be outfitted for this type of transfer arrangement. Accordingly, efficient transfer of cargo is not always achieved.

The third known alternative is the use RoadRailers®, i.e., truck trailers fitted with specially designed running gear so they can operate on both highways and railroad tracks. These trailers are trucked to loading stations where they are placed on railroad tracks and converted for rail operation. Once delivered, the trailers are then converted back to highway service and transported to final customer destinations. Again, this process enables only one trailer load of goods to be delivered at a time. Moreover, the use of RoadRailers® is not common, and outfitting an entire trucking fleet with RoadRailer® units is a costly expense for a trucking company. Finally, not all depots are outfitted to accommodate RoadRailers®.

A need exists in the art for a system that can be more cheaply implemented at existing railroad depots and that requires minimal, if any, modification to current railway and trucking equipment.

### SUMMARY OF THE INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof, as well as from the appended drawings.

It is an object of embodiments of the invention to provide an efficient centralized cargo transfer system. It is a further object of embodiments of the invention to provide an apparatus that can be used to facilitate the transfer of cargo on and off rail cars. These and other objects may be achieved through embodiments of the invention as described herein.

One embodiment of the invention is a movable transfer dock. A feature of this embodiment is a movable platform having a conveyor means thereon for facilitating movement of cargo atop the transfer dock. In use, the transfer dock is movable along a rail system positioned between rails cars and a staging area. Cargo can be, in one instance, unloaded from a truck and easily transferred, via the conveyor means, across the transfer dock directly into rail cars. In further embodiments, the transfer dock is movable to transfer cargo from one staging area to upstream or downstream rail cars. In other embodiments, the cargo is unloaded into cargo containers that are moved across the transfer dock and loaded directly into the rail car or truck using a container handling system.

In other embodiments of the invention, the transfer dock comprises an enclosure unit assembled to the platform to create a partially or fully enclosed unit. The transfer dock may then be air conditioned to accommodate the transfer of cargo between, for example, refrigerated rail cars and refrigerated trucks. The transfer dock may also include expandable seals for positioning between the doors of the enclosure unit and the applicable rail car and truck, as may be necessary, for example, to avoid the waste of energy if both the rail car or truck and transfer dock are refrigerated. In alternative embodiments, the transfer dock may be motorized to facilitate its movement along a rail way.

Through the use of one or more of the above described embodiments of the invention, a centralized depot can be created that is capable of accommodating disparate cargo from numerous trucks and rail cars and efficiently transferring that cargo to the appropriate rail car or truck.

In brief, one embodiment of the invention is a system for centralized transfer of cargo to and from rail cars comprising a first railway to accommodate the rail cars; a staging area; and a second railway positioned between the first railway and the staging area to accommodate a movable transfer dock; wherein the cargo is transferred between the staging area and the rail cars via the movable transfer dock.

Briefly, another aspect of the invention is a movable transfer dock for facilitating the transfer of cargo between a staging area and a rail car, comprising a movable platform having a conveyor means thereon.

It is to be understood that both the foregoing general description and the following detailed description are exemplary and are intended to provide further explanation of the invention claimed.

The accompanying drawings, which are incorporated in and constitute part of this specification, are included to illustrate and provide a further understanding of the features and embodiments of the invention. Together with the description, the drawings serve to explain the principles of the invention.

### BRIEF DESCRIPTION OF THE DRAWINGS

FIG. 1 is a representation of a central transfer facility in accordance with an embodiment of the invention.

FIG. 2A is a side view of an embodiment of a movable transfer dock in accordance with the present invention.

FIG. 2B is a top plan view of an embodiment of a movable transfer dock in accordance with the present invention.

FIG. 3 is a side view of a door of an embodiment of a movable transfer dock in accordance with the present invention.

FIG. 4A is one side view of an embodiment of a movable transfer dock and palletized cargo container in accordance with the present invention.

FIG. 4B is another side view of the embodiment of the movable transfer dock and palletized cargo container in accordance with the present invention as depicted in FIG. 4A.

FIG. 5A is a representation of a movable transfer dock in use at a central transfer facility in accordance with an embodiment of the present invention.

FIG. 5B is a representation of a movable transfer dock in use at a central transfer facility in accordance with an embodiment of the present invention.

FIG. 5C is a representation of a movable transfer dock in use at a central transfer facility in accordance with an embodiment of the present invention.

FIGS. 6A-6D are embodiments of the present invention depicting a means for temporarily securing the movable transfer dock to at least one of the rail cars.

### DETAILED DESCRIPTION OF THE PREFERRED EMBODIMENT

Reference will now be made in detail to the present preferred embodiments of the invention, examples and aspects of which are illustrated in the accompanying drawings. The features and elements of different embodiments of the invention will be described in conjunction with the detailed description provided below.

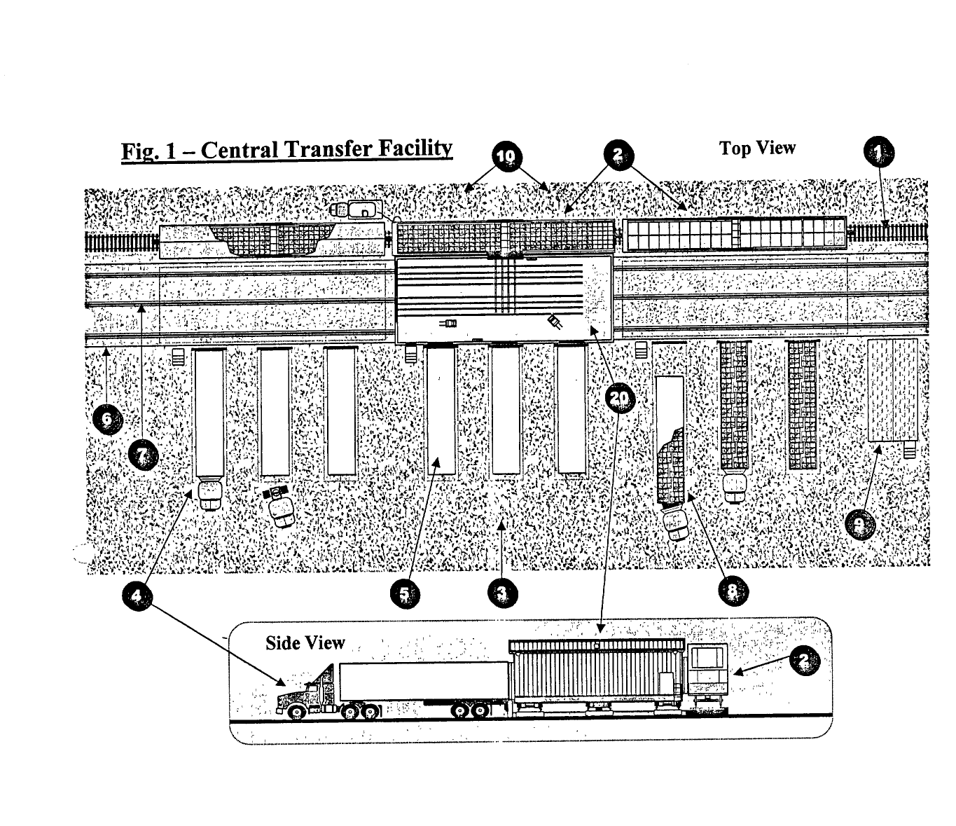

The invention presented herein may be used for centralized cargo transfer. The present invention is particularly suited for centralized cargo transfer between rail and truck transport vehicles. For purpose of explanation and illustration, and not limitation, an exemplary embodiment of the system in accordance with the invention is shown in FIG. 1 and is designated generally by reference character 10.

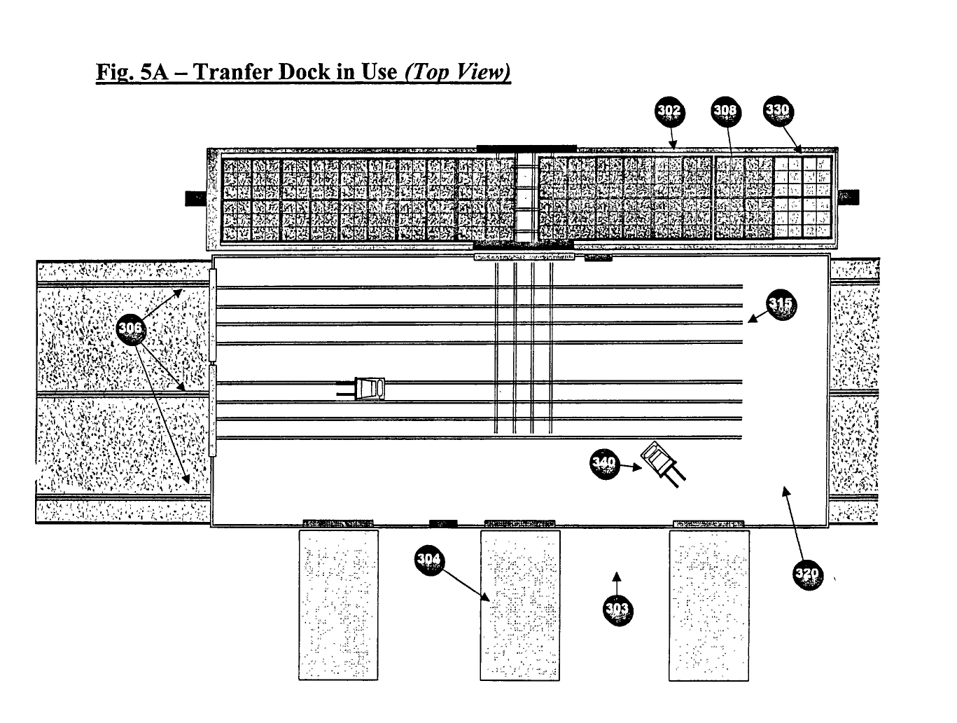

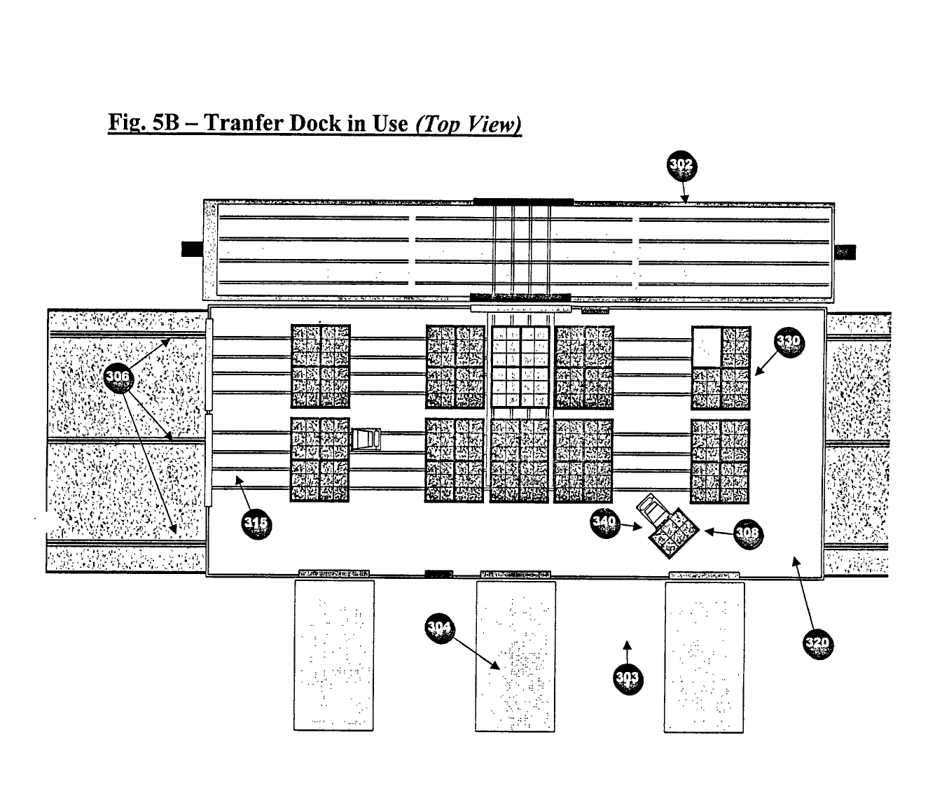

As shown in FIG. 1, the system 10 is generally described as system for centralized transfer of cargo to and from truck trailers and rail cars. The system 10 comprises a first railway 1 to accommodate rail cars 2. It will be understood that the reference to rail cars 2 may also include boxcars. In practice, the first railway 1 is likely to be any of the numerous rail lines currently used to transport goods or cargo. In addition, the first railway 1 may be a separate railway into and/or out of a loading station at some rail depot. Accordingly, the rails cars 2 may be coupled together as part of a longer train, or may be individual cars that have been decoupled and moved to a separate rail line for loading or unloading before being recoupled to the train. In addition, the rail cars 2 may be any type of rail car suitable for the transport of goods, including without limitation, refrigerated rail cars. The system 10 further comprises a staging area 3. The staging area 3 is typically a large area that abuts the rail depot to allow multiple trucks and other cargo-carrying vehicles to drive up for loading and unloading. In the present embodiment, trucks 4 back up onto the staging area 3 and unhitch their cargo-carrying trailers 5 for loading and unloading. The system 10 further comprises a second railway 6 positioned between the first railway 1 and the staging area 3 to accommodate a movable transfer dock 20. The movable transfer dock 20 will be described in further detail below. In the preferred embodiment, although not necessarily, the second railway 6 is wider than the first railway 1 and comprises two outside rails for engagement with the wheels of the transfer dock 20, and a center hot rail 7 for maintaining an electrical connection between a power source and the transfer dock 20. The transfer dock 20 is movable along the second railway 6 between trucks 4 in the staging area 3 and the appropriate rail car 2. In accordance with the present embodiment, cargo 8 is transferred via the transfer dock 20 between trucks 4 and the appropriate rail car 1. A detailed description of a transfer according to an embodiment of the present invention is provided below with reference to FIGS. 5A-5C.

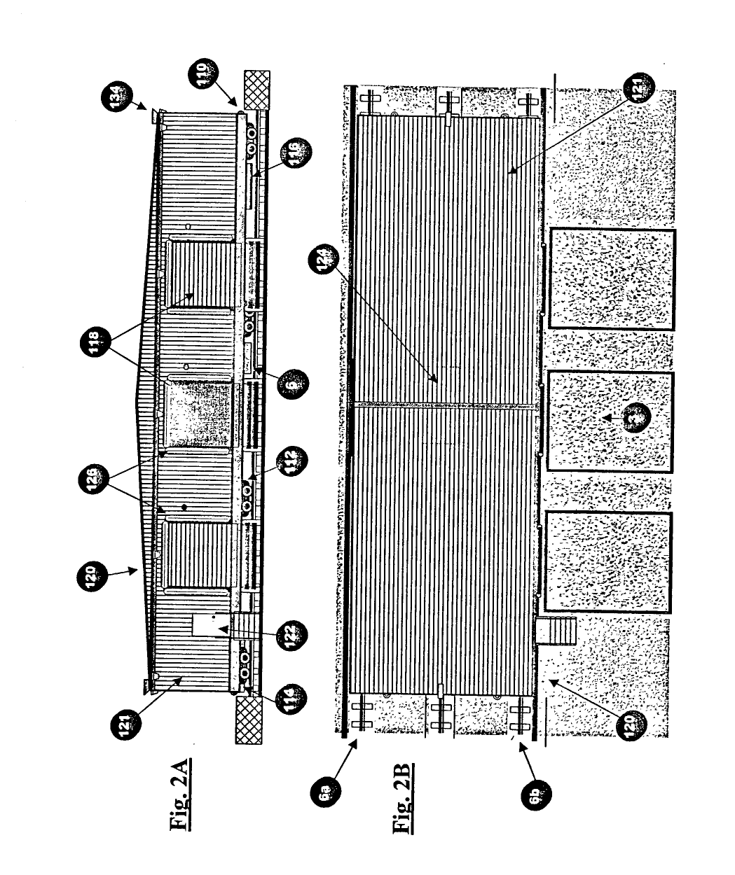

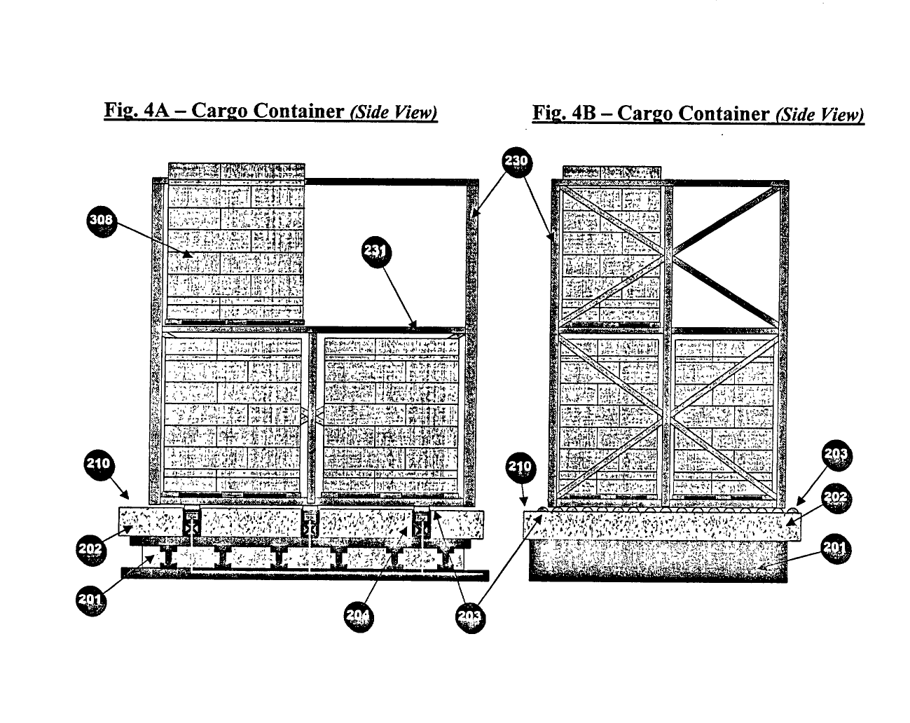

FIGS. 2A and 2B depict an embodiment of a movable transfer dock 120 in accordance with the present invention. The movable transfer dock 120 is but one embodiment of many movable transfer dock embodiments that are within the scope of the present invention and in accordance with the claims. In the present embodiment, the movable transfer dock 120 comprises a movable platform 110 having a plurality of wheels or rollers 112 thereunder to support the platform 110 on a plurality of rails 6a, 6b. In the preferred embodiment, although not necessarily, the platform 110 is approximately 80-85 feet long and 30-34 feet wide. It should be apparent, however, that the platform 110 could be built to any size, such as to accommodate the intended cargo or the space available at the transfer facility wherein it is to be used or to facilitate the efficient loading or unloading of cargo and/or cargo containers. In one embodiment, the transfer dock 120 includes a drive motor 114 mounted beneath the platform 110 for moving the transfer dock 120 along the railway 6. The drive motor 114 is coupled to some plurality of the wheels or rollers 112 via a transmission known in the art. In yet further embodiments, the transfer dock includes a pressurized air source 116, whose utility and advantages will be described in detail below with respect to FIGS. 4A and 4B.

The present embodiment of the transfer dock 120 further comprises an enclosure unit 121. The enclosure unit 121 is assembled to the platform 110 and comprises a plurality of side and end walls and a roof. The enclosure unit 121 further comprises a plurality of doors 118 receiving and depositing cargo. In the preferred embodiment, although not necessarily, the doors 118 are approximately 12-14 feet wide, depending upon whether the door 118 is to open adjacent a truck 4 or a rail car 2. Other design criteria may also be used in creating the doors 118 without limitation of the present invention. The enclosure unit 121 may also include one or more personnel doors 122 for the entry and exit of personnel working within the transfer dock 120.

In another embodiment of the transfer dock 120, the enclosure unit 121 includes a cooling unit 124 (depicted by dotted lines in FIG. 2B) such as an air conditioner or refrigeration unit. This embodiment is especially suited for the transfer of refrigerated or frozen goods between refrigerated trucks and refrigerated rail cars. In this embodiment, the entire transfer dock 120 may comprise one or more layers of insulation.

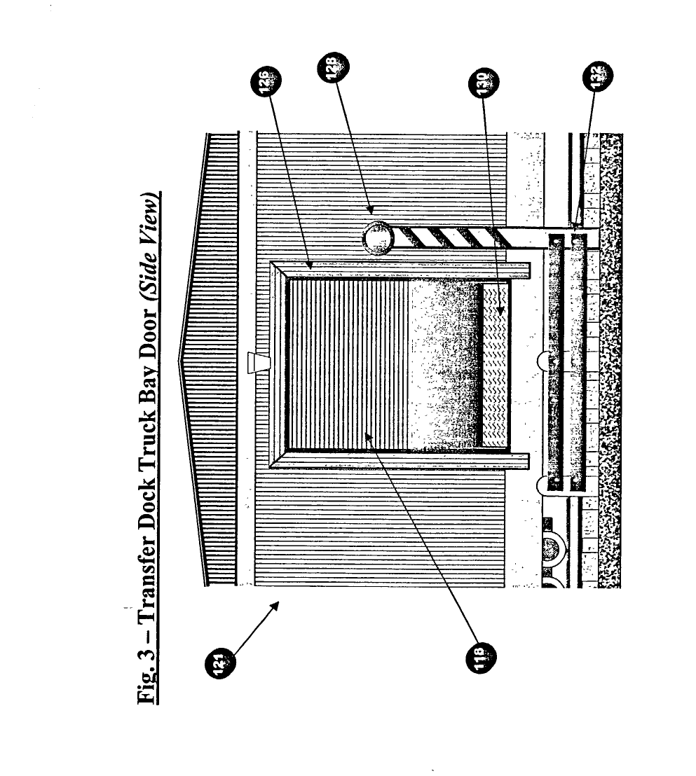

Referring to FIG. 3, to further conserve energy and maintain the temperature within the enclosure unit 121, the unit may be fitted with expandable seals 126 about the periphery of the doors 118. The expandable seals can be positioned to create a seal between the door 118 and a corresponding opening of a truck 4 or rail car 2. The curtain seals 118 can be expanded or retracted via air pressure from a pressurized air source 116. Alternatively, the curtain seals 118 may be connected to an outside pressure source at the depot wherein feeder lines running along the rails of the depot are hooked up to the transfer dock. The air pressure source 116 may also be used for charging railcar air brake systems or for pressurized car cleaning applications.

In yet further embodiments, the transfer dock 120 might include a back-up indicator 128. The back-up indicator 128 of the present embodiment includes a sensor that triggers an audible alarm if a truck 4 backs up too close to the transfer dock 120. The transfer dock 120 might also include a ramp extension 130 that may extend out from the door 118 to engage the unloading or loading end of the truck 4. The ramp extension 130 may be manually operable, or might be mechanically operable through, for example, hydraulic or pneumatic jacks or a motor. The transfer dock 120 could also include bumpers 132. In the preferred embodiment, the bumpers 132 are made of a resilient elastomeric material such as rubber and are mounted to the platform 110 in the area of the doors 118.

Referring again to FIG. 2A, the transfer dock 120 might comprise one or more video cameras 134. The video camera 134 can be, although is not necessarily, mounted onto or adjacent the exterior of the roof portion of the enclosure unit 121. The video camera 134 can be used to monitor the area surrounding the transfer dock 120 so that an operator on the inside of the enclosure unit 121 can operate the motor 114 to safely drive the transfer dock 120. The camera 134 may also be used for other safety or security purposes, such as to ensure that personnel are not on the tracks 6 in the vicinity of a moving transfer dock 120. The camera 134 could also be mounted within the enclosure unit 121 to monitor the activity of personnel while they are loading or unloading the transfer dock 120. In the preferred embodiment, the camera 134 is connected via a video connection to monitors within the enclosure unit 121. In alternative embodiments, signal may be sent from a transmitter coupled to the camera 134 to monitors at a coordinating station 9 at the transfer depot (see FIG. 1).

In alternative embodiments of the present invention, the transfer dock may be provided without an enclosure unit. Referring to FIGS. 4A and 4B, in this embodiment, the transfer dock 220 is essentially an open movable platform 210. In the preferred embodiment, the platform 210 comprises a base 201 having a top surface that includes a pre-cast concrete floor 202. The top surface floor might also be constructed of metal or some form of composite material.

In the preferred embodiment, the base 201 comprises a metal framework facilitating attachment of drive motors or other drive mechanisms and a conveyor means. The base may also include mechanisms for raising or lowering sections of or the floor 202. This ensures a level surface between the transfer dock surface and an interior railcar floor for moving specialized cargo containers in or out of the car.

In general, the transfer dock further comprises a conveyor means for facilitating movement of cargo or cargo containers. In one embodiment, the conveyor means for facilitating comprises a plurality of intersecting runners. In further embodiments, the conveyor means might comprise a plurality of mechanized conveyors, such as conveyor belts. In yet another embodiment, the conveyor means comprises a plurality of intersecting rollers that can be selectively raised above the surface of the floor using pneumatic pressure from a pressurized air source below.

The system according to the present invention could also include the use of palletized cargo containers 230 for storing cargo. The palletized cargo containers allow maximum efficient use of space within the rail cars and on the transfer dock. In addition, the palletized cargo containers help secure loads during shipment, minimizing load damage, and provide means for stacking cargo without crushing the loads. In the preferred embodiment, the containers are configured to handle eight (8) pallets of freight with individual load dimensions of 40″×48″×60″. The pallets are stacked four (4) pallets on top of each other utilizing a secondary tier within the container to separate the loads. It should be apparent, however, that containers of any dimension can be used to satisfy a desired design criteria. The containers 230 are preferably made of metal such as aluminum, iron or steel, or constructed entirely or in part using various composite materials. The containers 230 may also be coated with a protective covering for ease of cleaning and to prevent rust.

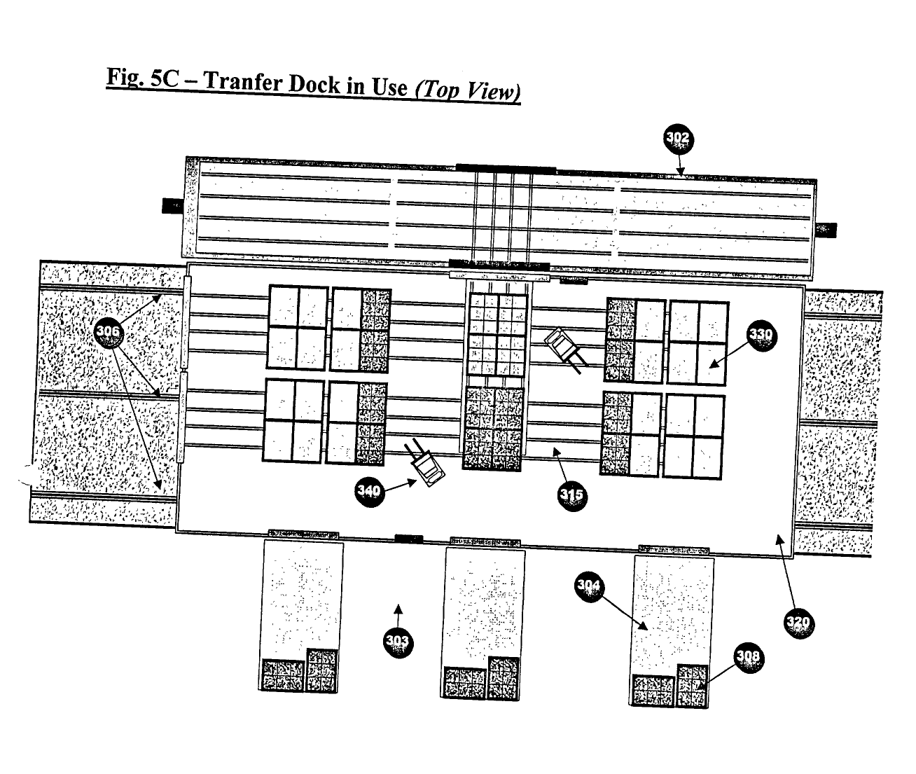

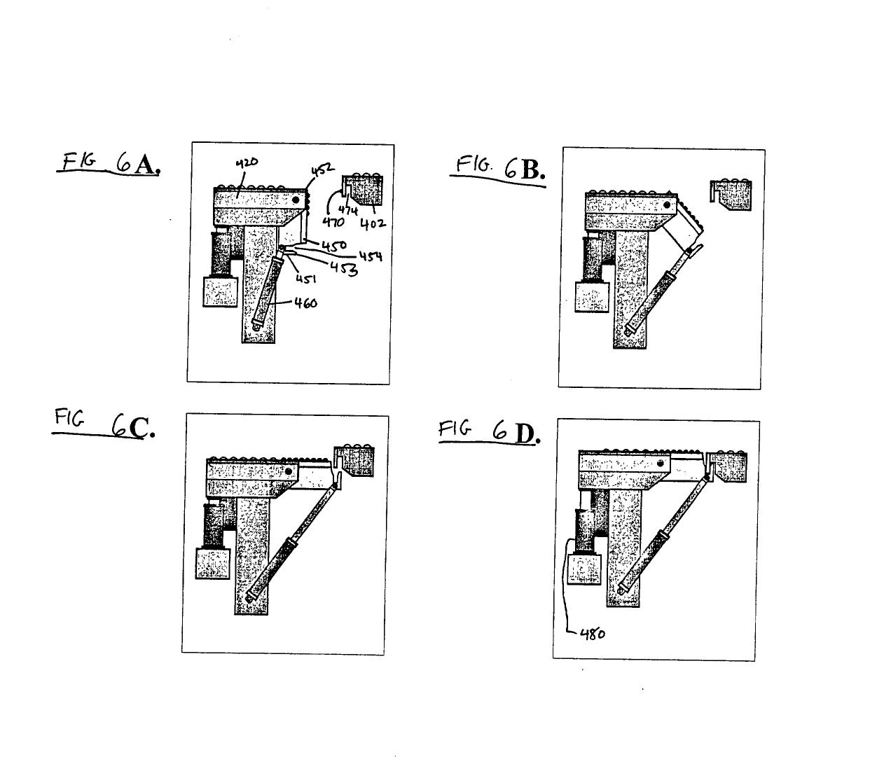

The transfer dock might also include some means for temporarily securing the transfer dock in place. In one embodiment, depicted in FIG. 6, the transfer dock might include pins that engage bores on the side of the rail cars for stabilizing the transfer dock.

Referring to FIGS. 5A-5C, the operation of an embodiment of the system of the present invention will now be described. Although the system is described herein with respect to the transfer of cargo from rail to truck, the present system is adaptable to transfer from truck to rail, or even from rail to rail without departing from the scope of the claims of the invention. In FIG. 5A, a rail car 302 is filled with cargo 308 stored in palletized cargo containers 330. Trucks 304 are awaiting loading in the staging area 303. Between the staging area 303 and the rail car 302 is a railway 306 with a movable transfer dock 320 thereon. The transfer dock 320 comprises a means 315 for facilitating movement of cargo, such as runners or rollers as described in detail above. Forklifts 340 are also available for moving the cargo 308 over the transfer dock 320.

In FIG. 5B, the palletized cargo containers 330 have been removed from the car 302 and move along the facilitating means 315 to a desired position on the transfer dock 320. Forklifts 340 remove cargo 308 from the containers 330 for loading onto the trucks 304.

In FIG. 5C, the forklifts 340 have transferred some of the cargo 308 into the trucks 304. As can be seen from this depiction, varied cargo 308 may be transported via the rail cars 302 and efficiently transferred to a plurality of trucks 304. When trucks 304 have been filled, or once car 302 has been emptied, the containers 330 can either be reloaded or moved as empties back into the rail car 302 for reverse shipment. The transfer dock 320 can then be disengaged from the rail car 302 and moved along the railway 306 to the next appropriate rail car spot for additional loading and unloading. Accordingly, efficient transfer of cargo between rail and truck is achieved.

FIGS. 6A-6D depict an embodiment of the present invention disclosing a particular means for temporarily securing the movable transfer dock to at least one of the rail cars. In this embodiment, the transfer dock 420 comprises a pivotal extension 450 connected at its distal end 451 to the transfer dock 420 via a jack 460 and pivotally connected at its opposite end 452 to the transfer dock 420. The jack 460 may be a hydraulic or pneumatic jack, or other mechanical mechanism for pivoting the pivotal extension 450. In the case of a hydraulic jack, the jack 460 is connected to the pressurized air source described above. The distal end 451 of the pivotal extension 450 also comprises a lip portion 453 which defines a groove 454 which preferably runs along the length of the outer periphery of the extension 450.

According to the preferred embodiment, the rail car 402 is outfitted with a lip portion 470 defining a groove 474 oppositely oriented to the lip portion 453 of the transfer dock 420. For instance, whereas the lip portion 453 of the transfer dock 420 defines an upwardly open groove 454 when the extension is fully pivoted, the rail car 402 has an oppositely (that is, downwardly) oriented groove 474. In this manner, the transfer dock extension lip portion 453 may be engaged in the rail car groove 474, while the rail car lip portion 470 may be engaged in the transfer dock extension groove 454.

When the transfer dock 420 is proximate the rail car 402, the jack 460 operates to pivot the extension 450 into a planar position with the top surface of the transfer dock 420 (see FIGS. 6B and 6C). Once the extension 450 is fully pivoted, another jack 480 connected to a pressure source (such as, for example, the pressurized air source described above if pneumatic jacks are utilized) raises the entire surface of the transfer dock so that the respective lip and groove portions are engaged. Thus, the transfer dock 420 is temporarily secured to the rail car 402. The process can be reversed (that is, the transfer dock 420 lowered and the extension 450 retracted) for disengaging the transfer dock 420 from the rail car 402. In alternative embodiments, the extension 450 may be provided without being pivotally connected. According to that embodiment, the lip portion and groove are thus permanently oriented for engagement with the rail car upon raising of the transfer dock 420.

It will be apparent to those skilled in the art that various modifications and variations can be made in the embodiments of the present invention without departing from the spirit or scope of the invention. Thus, it is intended that the present invention include modifications and variations that are within the scope of the appended claims and their equivalents.

What is claimed is:

1. A system for centralized transfer of cargo to and from rail cars comprising:
a first railway to accommodate the rail cars;
a staging area; and
a second railway positioned between the first railway and the staging area to accommodate a movable transfer dock;
wherein the cargo is transferred between the staging area and the rail cars via the movable transfer dock.

2. The system of claim 1 wherein the staging area is a truck loading and unloading zone.

3. The system of claim 1 wherein said rail cars are refrigerated rail cars.

4. The system of claim 1 further comprising palletized cargo containers for transporting the cargo to be transferred between the staging area and the rail cars.

5. The system of claim 1 wherein the movable transfer dock includes a means for positioning the movable transfer dock.

6. The system of claim 1 further comprising a means for temporarily securing the movable transfer dock to at least one of the rail cars.

7. The system of claim 4 wherein the movable transfer dock further comprises conveyor means for facilitating the movement of cargo.

8. The system of claim 1 wherein the movable transfer dock is a partially enclosed unit comprising a plurality of doors for receiving and depositing cargo.

9. The system of claim 8 wherein the movable transfer dock further comprises expandable curtain seals for sealing the area between at least one door and the rail cars.

10. The system of claim 1 wherein one or more of the rail cars are boxcars.

11. A movable transfer dock for facilitating the transfer of cargo between a staging area and a rail car or boxcar, comprising:
a movable platform having a plurality of wheels thereunder to support the platform on a plurality of rails;
a conveyor means for facilitating movement of cargo; and
a pressurized air source mounted to the platform.

12. The transfer dock of claim 11 further comprising insulation beneath the platform.

13. The transfer dock of claim 12 further comprising a drive motor mounted to the platform for moving the dock along the plurality of rails.

14. The transfer dock of claim 13 wherein the motor is mounted beneath the platform.

15. The transfer dock of claim 14 wherein the drive motor maintains an electrical connection with a hot rail.

16. The transfer dock of claim 11 further comprising bumpers about the periphery of the platform.

17. The transfer dock of claim 11 further comprising an enclosure unit assembled to the platform, the enclosure unit comprising a plurality of doors for receiving and depositing cargo.

18. The transfer dock of claim 17 further comprising curtain seals about the periphery of the doors.

19. The transfer dock of claim 17 further comprising a video camera mounted outside the enclosure unit.

20. The transfer dock of claim 17 further comprising an air conditioning unit for cooling the interior of the enclosure unit.

21. A system for centralized transfer of cargo to and from rail cars comprising:
a first railway to accommodate the rail cars;
a staging area;
a second railway positioned between the first railway and the staging area to accommodate a movable transfer dock; and
one or more palletized cargo containers adapted to hold the cargo;
wherein the palletized cargo containers are transferred between the staging area and the rail cars via the movable transfer dock.

22. The system of claim 21 wherein one or more of the rail cars are boxcars.
